(19) United States
(12) Patent Application Publication
(10) Pub. No.: US 2012/0236716 A1
(43) Pub. Date: Sep. 20, 2012

(54) PROFILE-BASED QUALITY OF SERVICE FOR WIRELESS COMMUNICATION SYSTEMS

(75) Inventors: Aravind Anbazhagan, Chennai (IN); Satish Kumar Ravishankar, Chennai (IN)

(73) Assignee: Atheros Communications, Inc., San Jose, CA (US)

(21) Appl. No.: 13/047,521

(22) Filed: Mar. 14, 2011

(51) Int. Cl. H04L 12/26

(52) U.S. Cl. 370/235

(57) ABSTRACT

A profile-based quality of service (QoS) priority assignment mechanism can be implemented in a wireless communication network. In one embodiment, a plurality of network identifiers (e.g., SSIDs) associated with a plurality of client network devices that are communicatively coupled with an access point of the wireless communication network are determined. It is further determined which QoS profile of a plurality of QoS profiles supported by the access point is associated with each network identifier associated with each of the plurality of client network devices. A plurality of pending communications associated with the plurality of network devices are detected. A QoS transmission priority level is assigned to each of the pending communications associated with the plurality of network devices based, at least in part, on the QoS profile associated with each pending communication. A transmission of data associated with one of the plurality of pending communications is initiated based, at least in part, on the QoS transmission priority level assigned to each pending communication.

### BACKGROUND

Embodiments of the inventive subject matter generally relate to the field of wireless communications systems, and, more particularly, to profile-based quality of service for wireless communication systems.

In wireless communication networks, carrier sense multiple access (CSMA) techniques can be used to provide network devices equal access to the communication medium. For example, the CSMA collision avoidance technique involves a listen-before-talk scheme to gain access to the communication medium. In the 802.11e amendment to the 802.11 standard (and also implemented in the 802.11n amendment), quality of service (QoS) mechanisms were introduced to wireless local area networks (WLANs) to provide certain network traffic categories that are considered high priority traffic preferential access to the communication medium over network traffic categories that are considered lower priority traffic. For example, a WLAN access point that implements the 802.11e/n standards typically apply a generic QoS priority assignment scheme to assign voice data the highest QoS priority, video data the second highest QoS priority, best effort (BE) data (e.g., IP data) the third highest QoS priority, and background (BK) data (e.g., email data) the lowest QoS priority.

### SUMMARY

Various embodiments for profile-based QoS in wireless communication networks are disclosed. In one embodiment, a plurality of network identifiers associated with a plurality of client network devices that are communicatively coupled with an access point of a communication network are determined. It is further determined which QoS profile of a plurality of QoS profiles supported by the access point is associated with each network identifier associated with each of the plurality of client network devices. A plurality of pending communications associated with the plurality of network devices are detected. A QoS transmission priority level is assigned to each of the pending communications associated with the plurality of network devices based, at least in part, on the QoS profile associated with each pending communication. A transmission of data associated with one of the plurality of pending communications is initiated based, at least in part, on the QoS transmission priority level assigned to each pending communication.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating a profile-based QoS priority assignment mechanism implemented in an access point of a wireless communication network;

FIG. 2 illustrates example QoS profiles that can be implemented in an access point and used to define the QoS priority levels for different network traffic categories;

FIG. 3 depicts a flow diagram illustrating example operations for implementing a profile-based QoS priority assignment mechanism in a wireless communication network;

FIG. 4 depicts a flow diagram illustrating additional example operations for implementing the profile-based QoS priority assignment mechanism in the wireless communication network; and

FIG. 5 is a block diagram of a wireless device configured to implement a profile-based QoS priority assignment mechanism in a wireless communication network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to implementing a profile-based quality of service (QoS) priority assignment mechanism in an access point of a wireless local area network (WLAN), the profile-based QoS priority assignment mechanism can be implemented in other suitable network devices, such as a client WLAN device operating as a mobile access point. In other instances, well-known instruction instances, protocols, structures, and techniques have not been shown in detail in order not to obfuscate the description.

In the 802.11e amendment to the 802.11 standard, QoS mechanisms were introduced to wireless local area networks (WLANs) to provide certain network traffic categories that are considered high priority traffic preferential access to the communication medium over network traffic categories that are considered lower priority traffic. However, the QoS mechanisms introduced by the 802.11e amendment typically apply a generic QoS priority assignment scheme to network traffic categories for all users of the WLAN. The generic QoS priority assignment scheme usually does not consider the different requirements or preferences that different users of the WLAN may have when connected to the WLAN. For example, the generic QoS priority assignment scheme typically assumes that all users of the WLAN require or prefer voice data to be assigned the highest QoS priority level, video data to be assigned the second highest QoS priority level, and BE/BK data to be assigned the lower QoS priority levels.

In some embodiments, a network coordinating device (e.g., an access point) in a wireless communication network (e.g., a WLAN) can be configured to implement a profile-based QoS priority assignment mechanism that assigns QoS priority levels to pending communications associated with client network devices. The profile-based QoS priority assignment mechanism assigns QoS priority levels based on the corresponding QoS profile associated with each network device and the network traffic category associated with each pending communication. The access point can determine the QoS profile associated with each network device (associated with each network user) based on the service set identifier (SSID) that each network device utilizes to wirelessly connect (e.g., authenticate and associate) with the access point. In one example, the access point can support multiple SSIDs in the WLAN. The network administrator may assign different SSIDs to the network users according to the requirements and/or preferences of each network user. Based on the QoS profiles associated with the corresponding SSIDs, the access point can then assign different QoS priority levels to pending communications with different network traffic categories to customize the QoS scheme implemented in the communication network according to each network user's requirements and/or preferences.

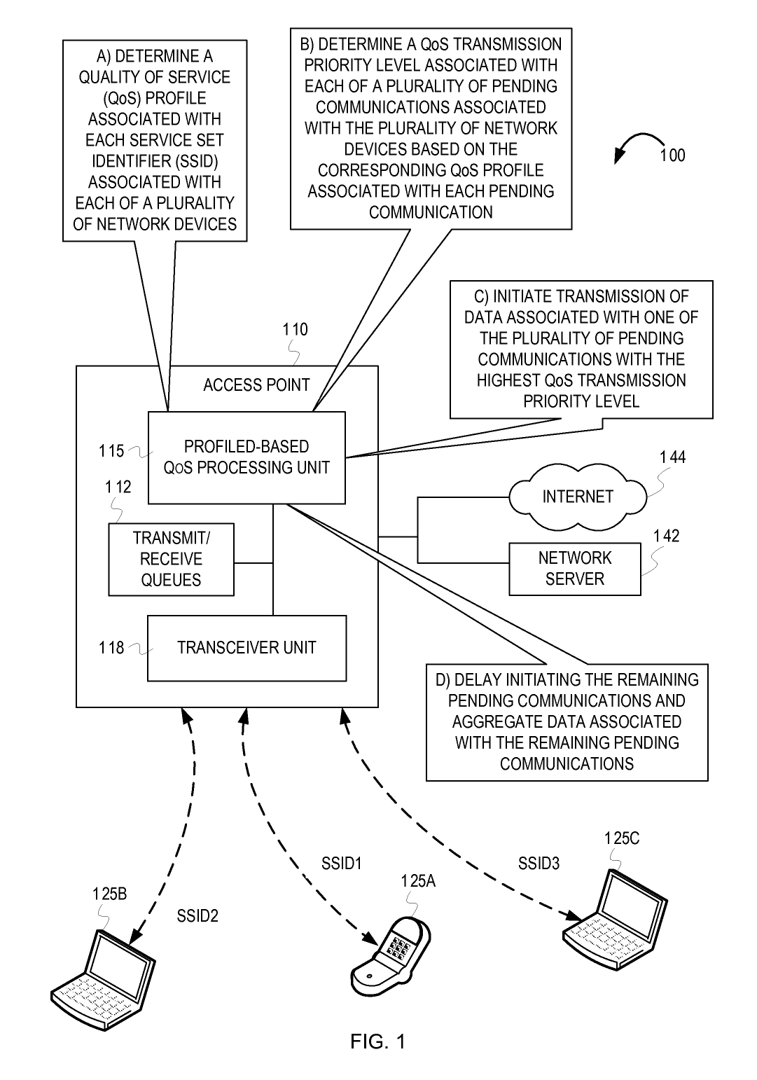

FIG. 1 is an example conceptual diagram illustrating a profile-based QoS priority assignment mechanism implemented in an access point of a wireless communication network. FIG. 1 depicts a communication network 100 (e.g., a WLAN) comprising an access point 110 and a plurality of network devices 125. The access point comprises a profile-based QoS processing unit 115, a transmit/receive queues 112, and a transceiver unit 118. The plurality of network devices 125 may be notebook computers, tablet computers, mobile phones, gaming consoles, and/or other electronic devices with WLAN communication capabilities.

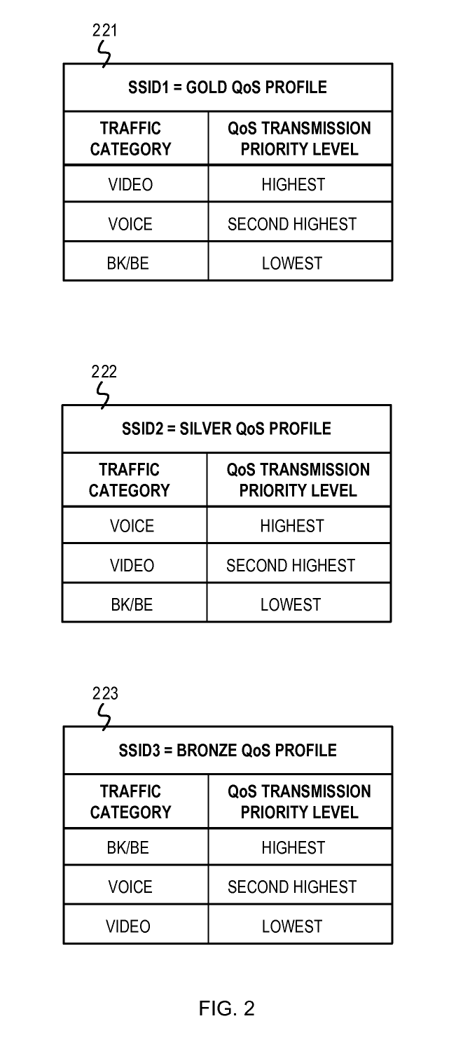

In some embodiments, the access point 110 may be configured to support multiple SSIDs. The profile-based QoS priority assignment mechanism implemented by the access point 110 can associate at least a subset of the SSID supported by the access point 110 with different predefined QoS profiles. Each QoS profile defines the QoS transmission priority levels that will be assigned to each of the predefined network traffic categories associated with pending communications that are detected in the communication network 100. In one example, the network administrator (or other user of the network 100) can create and/or customize a plurality of QoS profiles based on the expected requirements and/or preferences of the network users, and associate an SSID with each of the QoS profiles. In this example, the network administrator can instruct each of the network users (or configure the network devices of each of the network users) to connect with the access point 110 using one of the SSIDs selected based on the expected requirements and/or preferences of the network users. For example, as shown in chart 221 of FIG. 2, an SSID1 can be associated with a first QoS profile (e.g., which may be referred to as the Gold QoS profile) that assigns video data the highest QoS priority level, voice data the second highest QoS priority level, and BE/BK data the lowest QoS priority level. Network users (e.g., managers in a business) that prefer or require video data to have the highest QoS priority (e.g., because they may frequently participate in video conferences) can use the SSID1 to connect to the network 100. As shown in chart 222 of FIG. 2, an SSID2 can be associated with a second QoS profile (e.g., which may be referred to as the Silver QoS profile) that assigns voice data the highest QoS priority level, video data the second highest QoS priority level, and BE/BK data the lowest QoS priority level. Network users (e.g., lead engineers in a business) that prefer or require voice data to have the highest QoS priority (e.g., because they may frequently participate in VOIP-based meetings) can use the SSID2 to connect to the network 100. As shown in chart 223 of FIG. 2, an SSID3 can be associated with a third QoS profile (e.g., which may be referred to as a Bronze QoS profile) that assigns BE/BK data the highest QoS priority level, voice data the second highest QoS priority level, and video data the lowest QoS priority level. Network users (e.g., engineers/programmers in a business) that prefer or require BE/BK data to have the highest QoS priority (e.g., because they may utilize BE/BK data for most of their work projects) can use the SSID3 to connect to the network 100. Accordingly, the access point 110 can implement a profile-based (and SSID-dependent) QoS priority assignment mechanism for assigning QoS transmission priority levels for pending communications associated with the network devices 125, as will be described below in stages A-D of FIG. 1.

At Stage A, the QoS processing unit 115 determines a QoS profile associated with each SSID associated with each of the network devices 125. In one example, the QoS processing unit 115 can determine that network device 125A used the SSID1, network device 125B used SSID2, and network device 125C used SSID3 (e.g., during the association process) to wirelessly connect to the access point 110. The QoS processing unit 115 then determines that the Gold QoS profile is associated with the network device 125A, the Silver QoS profile is associated with the network device 125B, and the Bronze QoS profile is associated with the network device 125C.

At stage B, the QoS processing unit 115 can determine a QoS transmission priority level associated with each of a plurality of pending communications associated with the plurality of network devices 125 based on the QoS profile associated with each pending communication. The QoS processing unit 115 can determine the QoS profile associated with the SSID associated with each pending communication. The QoS processing unit 115 can then determine the QoS transmission priority level associated with each pending communication based on the QoS profile and the type of communication (e.g., network traffic category) associated with each pending communication. For example, the QoS processing unit 115 can detect a first pending communication associated with the network device 125A (and therefore associated with the SSID1), a second pending communication associated with the network device 125B (and therefore associated with the SSID2), and a third pending communication associated with the network device 125C (and therefore associated with the SSID3). The QoS processing unit 115 can then assign a QoS transmission priority level to the first pending communication based on the Gold QoS profile associated with the SSID1, assign a QoS transmission priority level to the second pending communication based on the Silver QoS profile associated with the SSID2, and assign a QoS transmission priority level to the third pending communication based on the Bronze QoS profile associated with the SSID3. For example, if the first, second and third pending communications are video data communications, the QoS processing unit 115 may assign the highest transmission QoS priority level to the first pending communication (based on the Gold QoS profile of chart 221), the second highest transmission QoS priority level to the second pending communication (based on the Silver QoS profile of chart 222), and the lowest QoS priority level to the third pending communication (based on the Bronze QoS profile of chart 223). In another example, the first pending communication may be a voice data communication, the second pending communication may be a video data communication, and the third pending communication may be a BK/BE data communication. In this example, the QoS processing unit 115 may assign the highest transmission QoS priority level to the third pending communication (based on the Bronze QoS profile), and assign the second highest transmission QoS priority level to both the first and second pending communications (based on the Gold QoS profile and the Silver QoS profile, respectively).

In some implementations, each of the pending communications detected by the QoS processing unit 115 can be a data communication (e.g., video, voice, or BK/BE data) that was received at the access point 110 from one of the network devices 125, in order for the access point 110 to transmit or forward the data to another network device 125 in the wireless network 100 (or another overlapping wireless network), to another network device in a different network (e.g., the network server 142 of a LAN or WAN), and/or to another network device on the Internet 144 (e.g., web server). Furthermore, some of the pending communications detected by the QoS processing unit 115 can be data communications (e.g., video, voice, or BK/BE data) intended for one or more of the network devices 125 that were received at the access point 110 from network devices in a different network (e.g., the network server 142 of a LAN or WAN), network devices on the Internet 144 (e.g., web servers), or other back-end network devices, in order for the access point 110 to transmit or forward the data to one or more of the network devices 125.

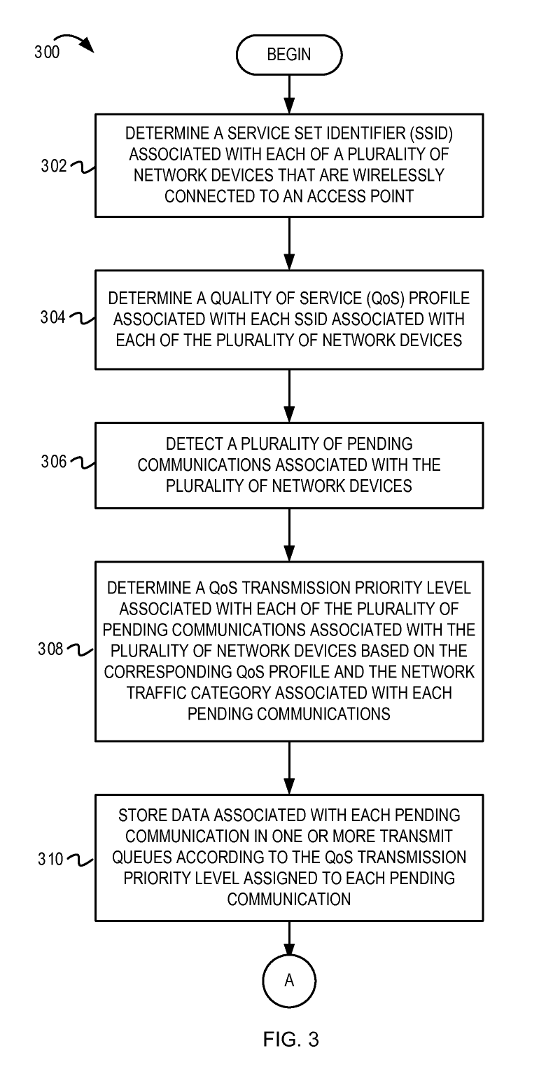

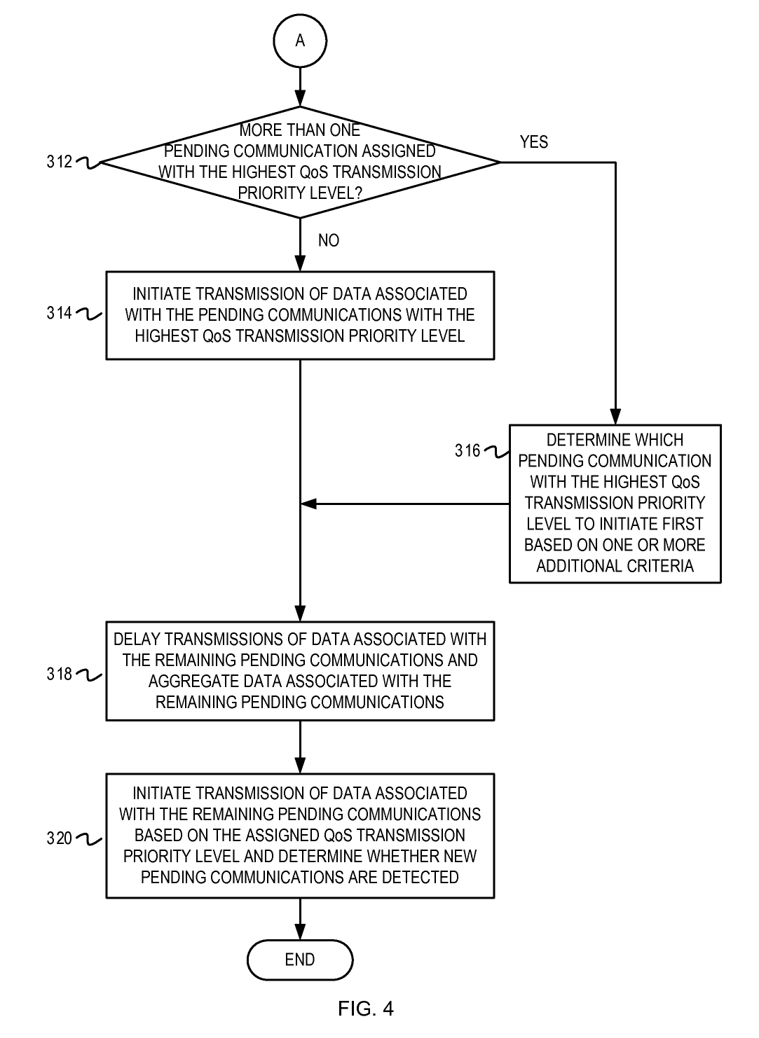

At stage C, the QoS processing unit 115 can initiate transmission of data associated with one of the pending communications with the highest QoS transmission priority level. For instance, in the example described above where the first, second and third pending communications are video data communications, the QoS processing unit 115 can initiate transmission of data associated with the first pending communication that was assigned the highest QoS transmission priority level based on the Gold QoS profile. For example, the QoS processing unit 115 can cause the transceiver unit 118 to transmit the first pending communication (e.g., stored in one of the transmit/receive queues 112) that was assigned the highest QoS transmission priority level. In some implementations, the QoS processing unit 115 can cause the transceiver unit 118 to transmit data associated with the pending communication with the highest QoS transmission priority level for a predefined transmission time window (e.g., 1 ms or 2 ms), as will be further described below with reference to FIGS. 3 and 4. If two or more of the pending communications are assigned the highest QoS transmission priority level (based on the QoS profiles), the QoS processing unit 115 can determine which pending communication that has been assigned the highest QoS transmission priority level to transmit first based on one or more additional criteria, as will be further described below with reference to FIGS. 3 and 4.

At stage D, the QoS processing unit 115 can delay initiating transmission of data associated with the remaining pending communications and aggregate the data associated with the remaining pending communications in the transmit/receive queues 112. In some implementations, the QoS processing unit 115 can cause the transmit/receive queues 112 to continue aggregating data associated with the remaining pending communications until each corresponding pending communication is scheduled for transmission (based on the QoS transmission priority level assigned based on the QoS profile). For example, while the access point 110 transmits the data associated with the pending communication with the highest QoS transmission priority level (e.g., for a predefined transmission time window), the transmit/receive queues 112 continue aggregating data associated with the pending communication with the second highest QoS transmission priority level and the pending communications with the lowest QoS transmission priority level. After the access point 110 completes transmission of the data associated with the pending communication with the highest QoS transmission priority level, the QoS processing unit 115 causes the transceiver unit 118 to begin transmitting data associated with the pending communication with the second highest QoS transmission priority level. Also, the transmit/receive queues 112 continue aggregating data associated with the pending communication with the lowest QoS transmission priority level. The access point 110 continues the process for all remaining pending communications and also implements the same process for all new pending communications and for new network devices that are detected in the network 100.

FIG. 3 and FIG. 4 depict a flow diagram (“flow”) 300 illustrating example operations for implementing a profile-based QoS priority assignment mechanism in a wireless communication network. The flow 300 begins at block 302.

At block 302, the SSIDs associated with the plurality of network devices 125 that are wirelessly connected to the access point 110 are determined. In some embodiments, the QoS processing unit 115 of the access point 110 (shown in FIG. 1) can determine the SSID associated with each of the plurality of network devices 125 that are wireless connected to the access point 110. As described above, in one example, the network administrator can assign an SSID to each user (or program the user's network device) based on the user's network preferences and/or requirements. In another example, the user may select one of the available SSIDs (and accordingly program the user's network device) based on the user's network preferences and/or requirements. Each network device 125 can then initiate the authentication and association processes with the access point 110. During the association process, each network device 125 can send an association request message to the access point 110 that includes the SSID that was assigned to the network device 125. The access point 110 can determine the SSID associated with each of the network devices 125 during the association process. Furthermore, in some implementation, the access point 110 can assign an association ID to each of the network devices 125 during the association process. The access point 110 can utilize the association ID to indicate the destination network device for a data transmission. For example, the access point 110 can include the association ID that was assigned to a destination network device (e.g., network device 125B) in a header of a data transmission that is sent from the access point 110 to the destination network device. Also, in some implementations, each network device 125 can utilize the assigned association ID in communications from the network device 125 to the access point 110 to indicate the source network device that originated the communication. After block 302, the flow continues at block 304.

At block 304, the QoS profile associated with each SSID associated with each of the plurality of network devices 125 is determined. In some embodiments, the QoS processing unit 115 can determine the QoS profile associated with each SSID associated with the plurality of network devices 125. For example, as shown in chart 221 of FIG. 2, an SSID1 can be associated with a first QoS profile (e.g., which may be referred to as the Gold QoS profile) that assigns video data the highest QoS priority level, voice data the second highest QoS priority level, and BE/BK data the lowest QoS priority level. As shown in chart 222 of FIG. 2, an SSID2 can be associated with a second QoS profile (e.g., which may be referred to as the Silver QoS profile) that assigns voice data the highest QoS priority level, video data the second highest QoS priority level, and BE/BK data the lowest QoS priority level. As shown in chart 223 of FIG. 2, an SSID3 can be associated with a third QoS profile (e.g., which may be referred to as a Bronze QoS profile) that assigns BE/BK data the highest QoS priority level, voice data the second highest QoS priority level, and video data the lowest QoS priority level. In the example shown in FIG. 1, the QoS processing unit 115 can determine that network device 125A used the SSID1, network device 125B used SSID2, and network device 125C used SSID3 (e.g., during the association process) to wirelessly connect to the access point 110. The QoS processing unit 115 then determines that the Gold QoS profile is associated with the network device 125A, the Silver QoS profile is associated with the network device 125B, and the Bronze QoS profile is associated with the network device 125C. In some implementations, after determining the QoS profile associated with each network device 125 based on the corresponding SSID, the QoS processing unit 115 can also relate the association ID that was assigned to each network device 125 to the QoS profile associated with each network device 125 (e.g., in order to identify communications from/to the network devices 125 that are received at the access point 110). For instance, in the example described above, the QoS processing unit 115 relates a first association ID with the network device 125A that is associated with the Gold QoS profile, relates a second association ID with the network device 125B that is associated with the Silver QoS profile, and relates a third association ID with the network device 125C that is associated with the Bronze QoS profile. After block 304, the flow continues at block 306.

At block 306, a plurality of pending communications associated with the plurality of network devices 125 are detected. In some embodiments, the QoS processing unit 115 can detect one or more pending communications associated with the plurality of network devices 125 of the network 100 (e.g., based on the association ID that was assigned to each network device 125). In one example, one or more of the pending communications detected by the QoS processing unit 115 can be data communications (e.g., video, voice, or BK/BE data) that were received at the access point 110 from the network devices 125. Each network device 125 can transmit data to the access point 110 in order for the access point 110 to transmit or forward the data to another network device 125 in the network 100 (or another overlapping wireless network), to another network device in a different network (e.g., the network server 142 of a LAN or WAN), and/or to another network device on the Internet 144 (e.g., web server). Furthermore, one or more of the pending communications detected by the QoS processing unit 115 can be data communications (e.g., video, voice, or BK/BE data) intended for one or more of the network devices 125 that were received at the access point 110 from network devices in a different network (e.g., the network server 142 of a LAN or WAN), network devices on the Internet 144 (e.g., web servers), or other back-end network devices, in order for the access point 110 to transmit or forward the data to one or more of the network devices 125. In some implementations, after receiving the data associated with the pending communications, the access point 110 can store the data in the receive queues 112 for further processing. After block 306, the flow continues at block 308.

At block 308, a QoS transmission priority level associated with each of the plurality of pending communications associated with the plurality of network devices 125 is determined based on the corresponding QoS profile and the network traffic category associated with each pending communication. In some embodiments, the QoS processing unit 115 can determine the QoS transmission priority level associated with each of the plurality of pending communications. The QoS processing unit 115 can determine the QoS transmission priority level of each pending communication after detecting the pending communication. For example, the QoS processing unit 115 can detect the SSID, the association ID, and the network traffic category (i.e., the type of communication) associated with each pending communication to determine the QoS transmission priority level associated with each pending communication. In one example, for each pending communication, the QoS processing unit 115 can determine the network device 125 associated with the pending communication based on the association ID included in the corresponding data packets (e.g., bits within the preamble/header of the data packets), and then determine the SSID and the QoS profile associated with the network device 125. In another example, the QoS processing unit 115 can determine the network device 125 and the QoS profile associated with the pending communication based on the association ID and the SSID included in the corresponding data packets. For instance, in the example described above, the QoS processing unit 115 can detect a first pending communication associated with the network device 125A and SSID1 (and therefore associated with the Gold QoS profile), a second pending communication associated with the network device 125B and SSID2 (and therefore associated with the Silver QoS profile), and a third pending communication associated with the network device 125C and SSID3 (and therefore associated with the Bronze QoS profile). The QoS processing unit 115 can also determine the network traffic category associated with the pending communication based on information included within the data packets (e.g., bits within the preamble/header of the data packets). In some implementations, after determining the network device 125, the QoS profile, and the network traffic category associated with each pending communication, the QoS processing unit 115 can determine the QoS transmission priority level associated with each pending communication. For instance, in the example described above, the QoS processing unit 115 can assign a QoS transmission priority level to the first pending communication that is defined by the Gold QoS profile according to the corresponding network traffic category, assign a QoS transmission priority level to the second pending communication that is defined by the Silver QoS profile according to the corresponding network traffic category, and assign a QoS transmission priority level to the third pending communication that is defined by the Bronze QoS profile according to the corresponding network traffic category. For example, if the first, second and third pending communications are video data communications, the QoS processing unit 115 may assign the highest transmission QoS priority level to the first pending communication (based on the Gold QoS profile shown in chart 221 of FIG. 2), the second highest transmission QoS priority level to the second pending communication (based on the Silver QoS profile shown in chart 222 of FIG. 2), and the lowest QoS priority level to the third pending communication (based on the Bronze QoS profile shown in chart 223 of FIG. 2). In another example, the first pending communication may be a voice data communication, the second pending communication may be a video data communication, and the third pending communication may be a BK/BE data communication. In this example, the QoS processing unit 115 may assign the highest transmission QoS priority level to the third pending communication (based on the Bronze QoS profile), and assign the second highest transmission QoS priority level to both the first and second pending communications (based on the Gold QoS profile and the Silver QoS profile, respectively). After block 308, the flow continues at block 310.

At block 310, after assigning the QoS transmission priority level to the pending communications, the QoS processing unit 115 can store the data associated with the pending communications in one or more transmit queues 112 of the access point 110 according to the QoS transmission priority level assigned to each pending communication. In one implementation, the access point 110 may implement and manage one or more transmit queues for storing data of each QoS transmission priority level. In this implementation, the QoS processing unit 115 can store the data associated with a pending communication that has been assigned a particular QoS transmission priority level in the corresponding transmit queue that stores data for that particular QoS transmission priority level. In another implementation, the QoS processing unit 115 can store the data associated with the pending communications in the one or more transmit queues according to an order of transmission determined from the assigned QoS transmission priority levels. In this implementation, the QoS processing unit 115 determines the order of transmission for the data associated with the pending communications based on the assigned QoS transmission priority levels (as will be further described below), and then stores the data associated with the pending communications in the one or more transmit queues based on the order of transmission. It is noted, however, that in other implementations, the access point 110 can implement other storage/memory mechanisms for temporarily storing the data associated with the pending communications. For example, the access point 110 can implement and manage a transmit queue for each pending communication. In this example, the access point 110 can transmit some or all of the data stored in the transmit queue associated with a pending communication depending on the QoS transmission priority level associated with the pending communication (and the transmission time window allotted for the transmission), and at the same time continues aggregating additional data that is received for the pending communication. After block 310, the flow continues at block 312 of FIG. 4.

At block 312, it is determined whether more than one of the pending communications is assigned the highest QoS transmission priority level. In one embodiment, the QoS processing unit 115 can determine whether more than one of the pending communications is assigned the highest QoS transmission priority level. If more than one pending communication is assigned the highest QoS transmission priority level, the flow continues at block 316. Otherwise, if one of the pending communications is assigned the highest QoS transmission priority level, the flow continues at block 314.

At block 314, a transmission of data associated with the pending communications with the highest QoS transmission priority level is initiated. In some embodiments, the QoS processing unit 115 can initiate transmission of data associated with the pending communications with the highest QoS transmission priority level. For instance, in the example described above where the first, second and third pending communications are video data communications, the QoS processing unit 115 can initiate transmission of data associated with the first pending communication that was assigned the highest QoS transmission priority level based on the Gold QoS profile. For example, the QoS processing unit 115 can cause the transceiver unit 118 to transmit the data associated with the first pending communication (e.g., stored in one of the transmit queues 112) that was assigned the highest QoS transmission priority level. In some implementations, the QoS processing unit 115 can cause the transceiver unit 118 to transmit data associated with the pending communication with the highest QoS transmission priority level for a predefined transmission time window. For example, the predefined transmission time window may be 1 ms or 2 ms (and may be configurable). In this implementation, the access point 110 may transmit as many data packets associated with the pending communication that can be transmitted during the predefined transmission time window. After the predefined transmission time window, if there is additional data in the transmit queues 112 associated with the pending communication, the data remains in the transmit queues 112 until the next time the access point 110 transmits data associated with the pending communication. Also, after the predefined transmission time window, the access point 110 can continue aggregating data (if any) associated with the pending communication. After block 314, the flow continues at block 318.

At block 316, if it is determined that two or more of the pending communications are assigned the highest QoS transmission priority level (based on the corresponding QoS profiles), the QoS processing unit 115 can determine which pending communication that has been assigned the highest (or the same) QoS transmission priority level to initiate first based on one or more additional criteria. In some implementations, if a pending voice data communication is assigned the highest QoS transmission priority level (e.g., according to the Gold QoS profile) and a pending BE/BK data communication is also assigned the highest QoS transmission priority level (e.g., according to the Bronze QoS profile), the QoS processing unit 115 can determine which of the two pending communications to initiate first based on a secondary priority assignment scheme. In other words, if two or more pending communications are assigned the same QoS transmission priority level (e.g., the highest QoS transmission priority level), the QoS processing unit 115 can determine which of the two or more pending communications to initiate first based on the secondary priority assignment scheme. In one example, if two or more pending communications are assigned the highest (or the same) QoS transmission priority level (based on the QoS profiles), the secondary priority assignment scheme can assign the highest secondary priority level to voice data communications (which may be the most sensitive to latency), the second highest secondary priority level to video data communications (which are also sensitive to latency), and the lowest secondary priority level to BK/BE data communications (which may be the least sensitive to latency). In other implementations, if two or more pending communications are assigned the highest (or the same) QoS transmission priority level (based on the QoS profiles), the QoS processing unit 115 may determine which of the two pending communications to transmit first based on a secondary priority level assigned to the different predefined QoS profiles. In other words, the QoS processing unit 115 can assign different secondary priority levels to the different predefined QoS profiles. For example, pending communications associated with the Gold QoS profile may be assigned the highest secondary priority level, pending communications associated with the Silver QoS profile may be assigned the second highest secondary priority level, and pending communications associated with the Bronze QoS profile may be assigned the lowest secondary priority level. In some implementations, if two or more of the pending communications are assigned the highest (or the same) QoS transmission priority level (based on the QoS profiles), the QoS processing unit 115 may also consider one or more additional criteria, such as a timestamp associated with the pending communication, the priority of the application and/or device that is associated with the pending communication, the user of the network that is associated with the pending communication, and/or other criteria or other secondary priority contention schemes to determine which pending communication to transmit first via the network 100. After block 316, the flow continues at block 318.

At block 318, transmissions of data associated with the remaining pending communications are delayed and data associated with the remaining pending communications is aggregated. In some embodiments, the QoS processing unit 115 can delay initiating transmission of data associated with the remaining pending communications and aggregate the data associated with the remaining pending communications in the transmit/receive queues 112. For example, the QoS processing unit 115 can cause the transmit/receive queues 112 to continue aggregating data associated with the remaining pending communications until each corresponding pending communication is scheduled for transmission (based on the QoS transmission priority level assigned based on the QoS profile). In one implementation, while the access point 110 transmits the data associated with the pending communication with the highest QoS transmission priority level for a predefined transmission time window, the transmit/receive queues 112 continue aggregating data associated with the remaining pending communications. For example, the transmit/receive queues 112 can continue aggregating data associated with the pending communication with the second highest QoS transmission priority level, and also continue aggregating data associated with the pending communications with the lowest QoS transmission priority level. In this example, after the access point 110 completes transmission of the data associated with the pending communication with the highest QoS transmission priority level (e.g., after the predefined transmission time window), the QoS processing unit 115 causes the transceiver unit 118 to begin transmitting data associated with the pending communication with the second highest (or next highest) QoS transmission priority level (e.g., for the predefined transmission time window). Also, the transmit/receive queues 112 continue aggregating data associated with the pending communication with the lowest QoS transmission priority level (or the next highest QoS transmission priority level). After block 318, the flow continues at block 320.

At block 320, initiate transmission of data associated with the remaining pending communications based on the assigned QoS transmission priority level and determine whether new pending communications are detected. In some embodiments, the QoS processing unit 115 can initiate transmission of data associated with the pending communication with the second highest QoS transmission priority level, and continue the same process of aggregating the remaining pending communication (and then repeat the process for the pending communication with the next highest QoS transmission priority level). Furthermore, during the process described above with reference to FIGS. 3 and 4, the QoS processing unit 115 can also determine whether new pending communications associated with the network devices 125 are detected, or whether new network devices attempt to wirelessly connect with the access point 110. If new pending communications and/or new network devices are detected, the QoS processing unit 115 can repeat the process described above with reference to blocks 302-320 of FIGS. 3 and 4.

It should be understood that the depicted diagrams (FIGS. 1-4) are examples meant to aid in understanding embodiments and should not be used to limit embodiments or limit scope of the claims. Embodiments may perform additional operations, fewer operations, operations in a different order, operations in parallel, and some operations differently. For instance, although some examples refer to implementing a profile-based QoS priority assignment mechanism in a stand-alone access point of a WLAN, the profile-based QoS priority assignment mechanism can be implemented in other suitable network devices, such as a client network device operating as a mobile access point, and/or in other types of wireless networks besides WLANs (e.g., Worldwide Interoperability for Microwave Access (WiMAX), 3GPP Long Term Evolution (LTE), etc.). Furthermore, the profile-based QoS priority assignment mechanism described above can be implemented in other types of network coordinating devices, such as a network device operating as a group owner in an ad-hoc network.

In some embodiments, the access point 110 may be configured with a plurality of predefined QoS profiles that are associated with a plurality of SSIDs that are supported by the access point 110. The access point 110 may also be configured to allow the network administrator to customize the operation of the access point 110 with respect to the profile-based QoS mechanism. For example, the network administrator can select predefined QoS profiles to associate with the SSIDs that are supported by the access point 110 and/or may customize predefined QoS profiles with desired QoS transmission priority levels for certain network traffic categories. In some implementations, the network administrator can customize one or more QoS profiles to assign the same QoS transmission priority level to two or more network traffic categories. For example, the network administrator can configure a QoS profile to assign the highest QoS transmission priority level to both voice and video data communications, and the second highest QoS transmission priority level to BK/BE data communications.

In some embodiments, instead of the network administrator or the user configuring the network device with a particular SSID based on the user's requirements and/or preferences, the access point 110 may be configured to automatically assign an SSID to each of the network devices based, at least in part, on each network device's historical network usage. For example, the access point 110 can track the network usage associated with each network device (based on device ID, association ID, or other identifiers) and determine that historically a certain percentage of the network usage associated with the network device is devoted for each of the different network traffic categories (i.e., network traffic that is transmitted from/to each network device via the access point). For example, the access point 110 can determine that historically 70% of the network usage associated with the network device is devoted for BK/BE data communications, 20% for video data communications, and 10% for voice data communications. The access point 110 can then assign an SSID (associated with a QoS profile) to the network device based on the historically network usage. For example, the access point 110 can assign an SSID associated with a QoS profile that assigns the highest QoS transmission priority to BK/BE data communications, the second highest QoS transmission priority to video data communications, and the lowest QoS transmission priority to voice data communications.

In some embodiments, the different QoS profiles associated with the different SSIDs that are supported by the access point 110 may each be assigned a different primary transmission priority level regardless of the network traffic category. For example, all network traffic categories associated with a first QoS profile (which is associated with a SSID1) may be assigned the highest QoS transmission priority level, all network traffic categories associated with a second QoS profile (which is associated with a SSID2) may be assigned the second highest QoS transmission priority level, and all network traffic categories associated with a third QoS profile (which is associated with a SSID3) may be assigned the lowest QoS transmission priority level. By implementing this type of QoS transmission priority assignment scheme, all of the network traffic associated with some network devices can be assigned higher QoS transmission priority levels (based on the QoS profiles associated with the SSIDs) compared to the network traffic associated with other network devices.

In some embodiments, after a first plurality of pending communications are assigned QoS transmission priority levels according to the operations described above with reference to FIGS. 1-4, if a plurality of new pending communications are detected in the network, the plurality of new pending communications are also assigned QoS transmission priority levels according to the operations described above with reference to FIGS. 1-4. After the priority assignments, in one example, the access point 110 can schedule the transmission of the first plurality of pending communications (according to the assigned priorities) prior to the transmission of the plurality of new pending communications. In another example, the access point 110 can consider the assigned QoS transmission priority levels of both the first plurality of pending communications (which have not been transmitted) and the plurality of new pending communications when determining which pending communication to initiate next according to the priority level (regardless of whether the new pending communications were detected later in time). However, in this example, the access point 110 may monitor some of the lower priority pending communications to try to ensure that these communications are not starved due to their relative low priority. For example, the access point 110 can implement a maximum wait time for each pending communication. For example, a timer associated with the maximum wait time can be initiated when the access point 110 detects a pending communication. If the maximum wait time associated with the pending communication expires, the access point automatically transmits the pending communication (e.g., after the current transmission is completed).

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a machine-readable storage medium, or a machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

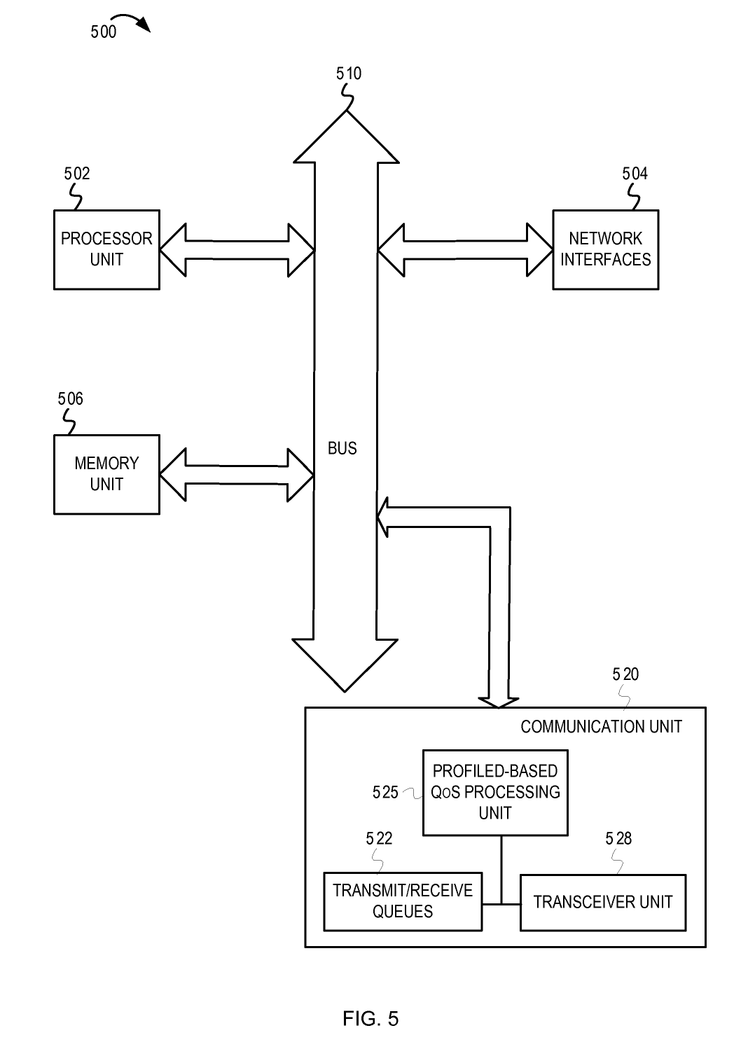

FIG. 5 is a block diagram of a wireless device 500 configured to implement a profile-based QoS priority assignment mechanism in a wireless communication network. In one implementation, the wireless device 500 may be a WLAN device (e.g., a WLAN chip or integrated circuit) included within an access point or other suitable network coordinating device capable of managing communications associated with client devices in a wireless communication network. In another implementation, the wireless device 500 may be a WLAN device included within a client device such as a mobile phone or other suitable electronic device capable of operating as a mobile access point. The wireless device 500 includes a processor unit 502 (possibly including multiple processors, multiple cores, multiple nodes, and/or implementing multi-threading, etc.). The wireless device 500 includes a memory unit 506. The memory unit 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The wireless device 500 also includes a bus 510 (e.g., PCI, ISA, PCI-Express, HyperTransport®, InfiniBand®, NuBus, etc.), and network interfaces 504 that include one or more of a wireless network interface (e.g., a WLAN interface, a Bluetooth® interface, a WiMAX interface, a ZigBee® interface, a Wireless USB interface, etc.) and a wired network interface (e.g., an Ethernet interface).

The wireless device 500 also includes a communication unit 520. In one implementation, the communication unit 520 comprises a profile-based QoS processing unit 525, a transceiver unit 528, and transmit/receive queues 522. The communication unit 520 is configured to implement a profile-based QoS priority assignment mechanism in a wireless communication network, e.g., as was described above with reference to FIGS. 1-4.

Any one of the above-described functionalities may be partially (or entirely) implemented in hardware and/or on the processor unit 502. For example, the functionality may be implemented with an application specific integrated circuit, in logic implemented in the processor unit 502, in a co-processor on a peripheral device or card, etc. Further, realizations may include fewer or additional components not illustrated in FIG. 5 (e.g., additional network interfaces, peripheral devices, etc.). The processor unit 502 and the network interfaces 504 are coupled to the bus 510. Although illustrated as being coupled to the bus 510, the memory 506 may be coupled to the processor unit 502.

While the embodiments are described with reference to various implementations and exploitations, it will be understood that these embodiments are illustrative and that the scope of the inventive subject matter is not limited to them. In general, profile-based quality of service for wireless communication systems as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a plurality of network identifiers associated with a plurality of client network devices that are communicatively coupled with an access point of a communication network;
determining which quality of service (QoS) profile of a plurality of QoS profiles supported by the access point is associated with each network identifier associated with each of the plurality of client network devices;
detecting a plurality of pending communications associated with the plurality of network devices;
assigning a QoS transmission priority level to each of the pending communications associated with the plurality of network devices based, at least in part, on the QoS profile associated with each pending communication; and
initiating a transmission of data associated with one of the plurality of pending communications based, at least in part, on the QoS transmission priority level assigned to each pending communication.

2. The method of claim 1, wherein the plurality of network identifiers associated with the plurality of client network devices comprise service set identifiers (SSIDs) associated with the plurality of network devices that are supported by the access point.

3. The method of claim 2, wherein said determining which QoS profile of the plurality of QoS profiles is associated with each network identifier associated with each of the plurality of client network devices further comprises:
determining a first QoS profile of the plurality of QoS profiles is associated with a first SSID associated with a first client network device;
determining a second QoS profile of the plurality of QoS profiles is associated with a second SSID associated with a second client network device; and
determining a third QoS profile of the plurality of QoS profiles is associated with a third SSID associated with a third client network device.

4. The method of claim 1, wherein said assigning the QoS transmission priority level to each of the pending communications associated with the plurality of network devices based, at least in part, on the QoS profile associated with each pending communication further comprises:
assigning the QoS transmission priority level to each of the pending communications associated with the plurality of network devices based on the QoS profile and a network traffic category associated with each pending communication.

5. The method of claim 4, wherein said assigning the QoS transmission priority level to each of the pending communications associated with the plurality of network devices based on the QoS profile and the network traffic category associated with each pending communication further comprises:
for each pending communication,
determining which client network device of the plurality of client network devices is associated with the pending communication;
determining the QoS profile associated with the client network device that is associated with the pending communication;
determining the network traffic category associated with the pending communication;
determining the QoS transmission priority level assigned to the network traffic category associated with the pending communication based on QoS transmission priority level assignments defined in the QoS profile associated with the client network device; and
assigning the QoS transmission priority level to the pending communication associated with the client network device.

6. The method of claim 1, wherein said initiating a transmission of data associated with one of the plurality of pending communications based, at least in part, on the transmission priority level assigned to each pending communication further comprises:
determining which pending communication of the plurality of pending communications is assigned a highest QoS transmission priority level; and
initiating a transmission of data associated with the pending communication that is assigned the highest QoS transmission priority level.

7. The method of claim 6, further comprising:
delaying transmissions of data associated with remaining one or more of the plurality of pending communications based, at least in part, on the transmission priority level assigned to each of the remaining one or more of the plurality of pending communications.

8. The method of claim 7, wherein said delaying transmissions of data associated with remaining one or more of the plurality of pending communications further comprises:
delaying transmissions of data associated with the remaining one or more of the plurality of pending communications at least until the transmission of data associated with the pending communication with the highest QoS transmission level is completed; and
aggregating data associated with the remaining one or more of the plurality of pending communications at least until the transmission of data associated with the pending communication with the highest QoS transmission level is completed.

9. The method of claim 1, wherein said determining the plurality of network identifiers associated with the plurality of client network devices that are communicatively coupled with the access point of the communication network further comprises:
for each client network device,
detecting an association request message from the client network device; and
determining a network identifier associated with the client network device from information included within the association request message.

10. A wireless communication network device comprising:
a processor;
a network interface coupled to the processor; and
a quality of service (QoS) processing unit operable to:
determine a plurality of network identifiers associated with a plurality of client network devices that are communicatively coupled with the wireless communication network device;
determine which QoS profile of a plurality of QoS profiles is associated with each network identifier associated with each of the plurality of client network devices;
detect a plurality of pending communications associated with the plurality of network devices;
assign a QoS transmission priority level to each of the pending communications associated with the plurality of network devices based, at least in part, on the QoS profile associated with each pending communication; and
initiate a transmission of data associated with one of the plurality of pending communications based, at least in part, on the QoS transmission priority level assigned to each pending communication.

11. The wireless communication network device of claim 10, wherein the plurality of network identifiers associated with the plurality of client network devices comprise service set identifiers (SSIDs) associated with the plurality of network devices that are supported by wireless communication network device.

12. The wireless communication network device of claim 10, wherein the QoS processing unit operable to assign the QoS transmission priority level to each of the pending communications associated with the plurality of network devices based, at least in part, on the QoS profile associated with each pending communication further comprises the QoS processing unit operable to:
assign the QoS transmission priority level to each of the pending communications associated with the plurality of network devices based on the QoS profile and a network traffic category associated with each pending communication.

13. The wireless communication network device of claim 12, wherein the QoS processing unit operable to assign the QoS transmission priority level to each of the pending communications associated with the plurality of network devices based on the QoS profile and the network traffic category associated with each pending communication further comprises the QoS processing unit operable to:
for each pending communication,
determine which client network device of the plurality of client network devices is associated with the pending communication;
determine the QoS profile associated with the client network device that is associated with the pending communication;
determine the network traffic category associated with the pending communication;
determine the QoS transmission priority level assigned to the network traffic category associated with the pending communication based on QoS transmission priority level assignments defined in the QoS profile associated with the client network device; and
assign the QoS transmission priority level to the pending communication associated with the client network device.

14. The wireless communication network device of claim 10, wherein the QoS processing unit operable to initiate a transmission of data associated with one of the plurality of pending communications based, at least in part, on the transmission priority level assigned to each pending communication further comprises the QoS processing unit operable to:
determine which pending communication of the plurality of pending communications is assigned a highest QoS transmission priority level; and
initiate a transmission of data associated with the pending communication that is assigned the highest QoS transmission priority level.

15. The wireless communication network device of claim 14, wherein the QoS processing unit is further operable to:
delay transmissions of data associated with remaining one or more of the plurality of pending communications based, at least in part, on the transmission priority level assigned to each of the remaining one or more of the plurality of pending communications.

16. The wireless communication network device of claim 15, wherein the QoS processing unit operable to delay transmissions of data associated with remaining one or more of the plurality of pending communications further comprises the QoS processing unit operable to:
delay transmissions of data associated with the remaining one or more of the plurality of pending communications at least until the transmission of data associated with the pending communication with the highest QoS transmission level is completed; and
aggregating data associated with the remaining one or more of the plurality of pending communications at least until the transmission of data associated with the pending communication with the highest QoS transmission level is completed.

17. The wireless communication network device of claim 10, wherein the QoS processing unit operable to determine the plurality of network identifiers associated with the plurality of client network devices that are communicatively coupled with the wireless communication network device further comprises the QoS processing unit operable to:
for each client network device,
detect an association request message from the client network device; and
determine a network identifier associated with the client network device from information included within the association request message.

18. One or more machine-readable storage media, having instructions stored therein, which, when executed by one or more processors causes the one or more processors to perform operations that comprise:
determining a plurality of service set identifiers (SSIDs) associated with a plurality of client network devices that are communicatively coupled with an access point of a communication network;
determining which quality of service (QoS) profile of a plurality of QoS profiles supported by the access point is associated with each SSID associated with each of the plurality of client network devices;
detecting a plurality of pending communications associated with the plurality of network devices;
assigning a QoS transmission priority level to each of the pending communications associated with the plurality of network devices based, at least in part, on the QoS profile and a network traffic category associated with each pending communication; and
initiating a transmission of data associated with one of the plurality of pending communications based, at least in part, on the QoS transmission priority level assigned to each pending communication.

19. The machine-readable storage media of claim 18, wherein said operation of assigning the QoS transmission priority level to each of the pending communications associated with the plurality of network devices based on the QoS profile and the network traffic category associated with each pending communication further comprises:
for each pending communication,
determining which client network device of the plurality of client network devices is associated with the pending communication;
determining the QoS profile associated with the client network device that is associated with the pending communication;
determining the network traffic category associated with the pending communication;
determining the QoS transmission priority level assigned to the network traffic category associated with the pending communication based on QoS transmission priority level assignments defined in the QoS profile associated with the client network device; and
assigning the QoS transmission priority level to the pending communication associated with the client network device.

20. The machine-readable storage media of claim 18, wherein said operation of initiating a transmission of data associated with one of the plurality of pending communications based, at least in part, on the transmission priority level assigned to each pending communication further comprises:
determining which pending communication of the plurality of pending communications is assigned a highest QoS transmission priority level; and
initiating a transmission of data associated with the pending communication that is assigned the highest QoS transmission priority level.

21. The machine-readable storage media of claim 20, wherein the operations further comprise:
delaying transmissions of data associated with remaining one or more of the plurality of pending communications based, at least in part, on the transmission priority level assigned to each of the remaining one or more of the plurality of pending communications.

22. The machine-readable storage media of claim 21, wherein said operation of delaying transmissions of data associated with remaining one or more of the plurality of pending communications further comprises:
delaying transmissions of data associated with the remaining one or more of the plurality of pending communications at least until the transmission of data associated with the pending communication with the highest QoS transmission level is completed; and
aggregating data associated with the remaining one or more of the plurality of pending communications at least until the transmission of data associated with the pending communication with the highest QoS transmission level is completed.

23. The machine-readable storage media of claim 18, wherein said operations further comprise:
in response to determining that two or more of the plurality of pending communications are assigned a highest QoS transmission priority level,
determining which of the two or more of the plurality of pending communications to initiate first based, at least in part, on a secondary QoS transmission priority level assigned to the QoS profiles associated with the two or more of the plurality of pending communications.
